(19) United States
(12) Patent Application Publication
(10) Pub. No.: US 2007/0053653 A1
(43) Pub. Date: Mar. 8, 2007

(54) Method and system to control operation of a media playback device

(75) Inventor: Matthew Huntington, Mill Valley, CA (US)

Correspondence Address: SCHWEGMAN, LUNDBERG, WOESSNER & KLUTH/OPEN TV, P.O. BOX 2938, MINNEAPOLIS, MN, 55402-0938, US

(73) Assignee: OpenTV, Inc.

(21) Appl. No.: 11/223,253

(22) Filed: Sep. 6, 2005

(51) Int. Cl. H04N 5/91

(52) U.S. Cl. 386/46

(57) ABSTRACT

A method and system is described to control operation of a playback device. The method may include receiving a trigger signal generated automatically without human intervention by an external device, and performing a selected operation on digital content being played back when the trigger signal is received. The playback device may include a Personal Video Recorder (PVR) and the external trigger signal may be received from the external device that is separate from a handheld remote control associated with the playback device. In an example embodiment, the trigger signal is received directly from a telephony network, the trigger signal being an incoming call to a telephony device. In addition or instead, the trigger signal may be received indirectly from a telephony device via a television network.

### TECHNICAL FIELD

The present application relates generally to the technical field of media playback devices. For example, an embodiment of the invention relates to controlling operation of a digital multimedia recording/playback device that receives television signals.

### BACKGROUND

Playback devices such as Set-Top Boxes (STB) are electronic devices that are connected to a communication channel, such as a phone, ISDN or cable television line, and produce an output on a display device such as a conventional television screen.

Set-top boxes may be used to receive and decode digital television signals and output them to a user's television. Some Set-top boxes simply receive and unscramble incoming television signals while more complex STBs also function as multimedia desktop computers that can run a variety of advanced services such as videoconferencing, home networking, IP telephony, video-on-demand (VoD) and high-speed Internet TV services.

A Set-Top Box typically includes a Personal Video Recorder (PVR). A PVR is a device that is similar to a Video Cassette Recorder (VCR) but records television data in digital format as opposed to the VCR's analog format. VCRs utilize analog tapes to record and play programs broadcast over television, but PVRs encode video data and store the data in a hard drive. PVRs typically have the same functionality of VCRs (recording, playback, fast forwarding, rewinding, and pausing). Commercially available PVR technology is available from OpenTV, TiVo and ReplayTV.

PVRs allow a viewer to pause playback of both recorded programs as well as “live” programming. When a live program is paused or stopped, a recording device continues to recode the “live” program whilst it is paused but the actual rendering on the screen may be frozen. When a viewer resumes play, the program is played back to the viewer from the recording device (e.g., a hard disk) and it may thus appear to the viewer that the live program was in fact paused.

In the prior art, a viewer must actively find the remote control and activate to pause button to pause the program.

### SUMMARY

A method and system to control operation of a playback device for playing back digital media is provided. The method may include receiving a trigger signal at the playback device, the trigger signal being generated automatically without human intervention by an external device; and performing at the playback device a selected operation on digital content being played back when the trigger signal is received.

The invention extends to a machine-readable medium for performing any one or more of the methodologies described herein.

Other features will be apparent from the accompanying drawings and from the detailed description that follows.

### BRIEF DESCRIPTION OF THE DRAWINGS

Embodiments of the present invention are illustrated by way of example, and not limitation, in the figures of the accompanying drawings, and in which like references indicate the same or similar elements.

In the drawings,

FIG. 1 shows architecture of an example embodiment of a networked system in which content is broadcast to a playback device without a direct telephony interface;

FIG. 2 shows architecture of an example embodiment of a networked system in which content is broadcast to a playback device with a direct telephony interface;

FIG. 3 shows architecture of an example embodiment of the payback device;

FIG. 4 shows flow diagram of an example method to control operation of playback device; and

FIG. 5 shows a diagrammatic representation of a machine, in the example form of a computer, within which a set of instructions for causing the machine to perform any one or more of the methodologies discussed herein may be executed.

### DETAILED DESCRIPTION

A method and system to control operation of a playback device are described. In the following description, for purposes of explanation, numerous specific details are set forth in order to provide a thorough understanding of embodiments of the present invention. It will be evident, however, to one skilled in the art that the present invention may be practiced without these specific details.

Merely by way of example, content played back or output by the playback device may include television programs or the like communicated via any content distribution channel (e.g., satellite TV, cable TV, or the like). The content may also be distributed to any platform. For the purposes of this specification, the term “playback device” includes and digital media rendering or output device and includes mobile platforms (e.g., a cellular telephone, a Personal Digital Assistant (PDA), portable computer, or the like) or any other device capable of rendering or playing back any digital content (including audio and/or video).

In an example embodiment, the method and system are deployed in a Set-Top Box (STB) including PVR functionality. The STB may be connected to a communication channel, such as a DSL line, an ADSL line, an ISDN line, cable television line, satellite television link, or the like to receive digital content. For example, the STB may receive multimedia broadcasts such as television broadcasts which are then output for display on a conventional television set. It will be appreciated that the method and system may also be integrated within a display device such as a television set.

As described in more detail below, in an example embodiment a playback device includes a controller that performs a selected operation (e.g., pauses playback or outputting, bookmarks, stops playback, or the like) when a trigger signal is received from an external device other than, for example, a hand-held remote control of the playback device.

Referring to the drawings, reference 10 generally indicates architecture of an example embodiment of a networked system in which content is broadcast via a television network to a playback device without a direct telephony interface. In the example system 10, the playback device is shown to be a set-top box 12 which includes a Personal Video Recorder (PVR) with a digital storage device 14 (e.g., a hard disk drive) for storing digital content. In the system 10, as shown by arrows 16, digital content such as television programs are communicated via a television network 18 to the set-top box 12. The television network 18 may, for example, be a wired network such as a cable television network, a satellite television network, or the like. As described in more detail below, the set-top box 12 may receive a trigger signal 20 from an external device. In an embodiment, the trigger signal 20 is generated by a telephone switch 22 in response to an incoming telephone call. For example, a telephone 24 may be provided at subscriber premises where the set-top box 12 is located and, accordingly, the trigger signal 20 may be generated when a telephone call is made to the telephone 20.

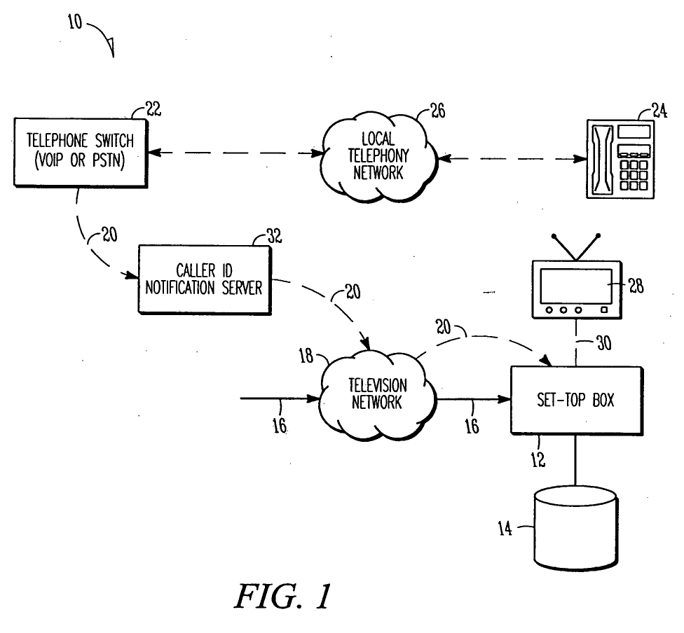

In the example embodiment shown in FIG. 1, the telephone 24 is connected by a wired connection via a local telephony network 26 to the telephone switch 22. The set-top box 22 is connected to a display device such as a television set 28 via a connection 30 may output live TV to the television set 28. Thus, in the example embodiment, when a viewer is watching a television program, either live or replayed from the storage device 14, and the trigger signal 20 is generated, the set-top box 12 may perform a selected operation on the digital content being played back when the trigger signal is received. For example, the set-top box may pause, playing, or outputting of the digital content to the television set 28.

The system 10 may optionally include a identification functionality, for example, a caller ID notification server 32 that provides caller identification information which may be included in the trigger signal 20. The caller identification information may be used by the set-top box 12 to identify a caller calling the telephone 24. In an embodiment, the identity of the caller may be displayed on the television set 28.

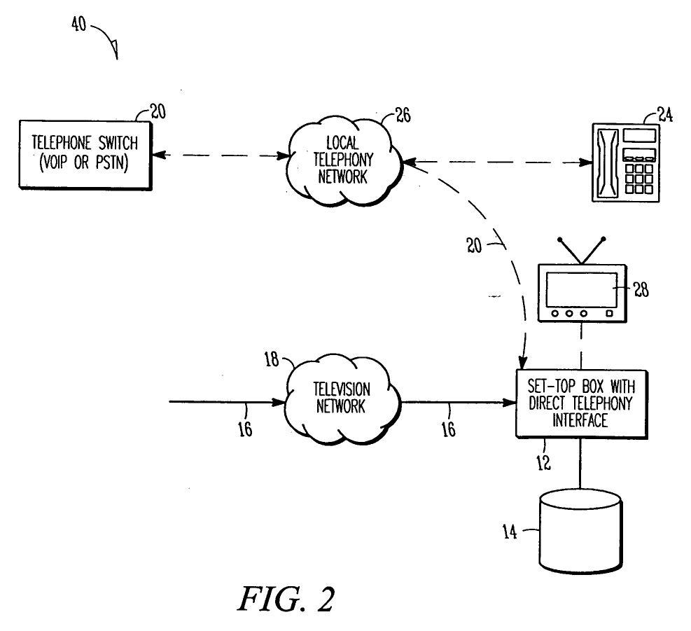

Referring in particular to FIG. 2, reference 40 generally indicates architecture of an example embodiment of a networked system in which content is broadcast to a playback device with a direct telephony interface. The system 40 resembles the system 10 and, accordingly, like reference numerals have been used to indicate the same or similar features. However, unlike the system 10 where the trigger signal 20 is included “in-band” and is provided to the set-top box 12 via the television network 18, in the system 40, the set-top box 12 is directly coupled to the local telephony network 26. For example, the set-top box 12 may be connected by a cable to a conventional telephone jack provided in a subscriber's home. As in the case of the system 10, the trigger signal 20 may include caller identification information for processing via the set-top box 12 and display on the television set 28.

In the example systems 10, 40 shown in FIGS. 1 and 2, the external device generating the trigger signal is shown to be a telephone. However, it is to be appreciated that the external device may be any device requiring attention from a viewer. For example, the external device may include domestic appliances such as ovens, doorbells, baby monitors, or any other devices requesting the attention of a viewer and thus interrupting viewing of digital content (e.g. a television program) output from the set-top box 12 to the television set 28. In an embodiment, the trigger event may be the arrival of an email (e.g., received by a personal computer, mobile device such as a “BlackBerry” or the like).

It will be appreciated that the selected operation need not be limited to pausing outputting of the digital content, but may include decreasing audio volume, pausing playback, stopping playback, creating a bookmark, requesting confirmation from the viewer that a bookmark be created, requesting confirmation from the viewer that playback be stopped, requesting confirmation from the viewer that playback be paused, requesting confirmation from the viewer that audio volume be decreased, or any other appropriate action required by the viewer.

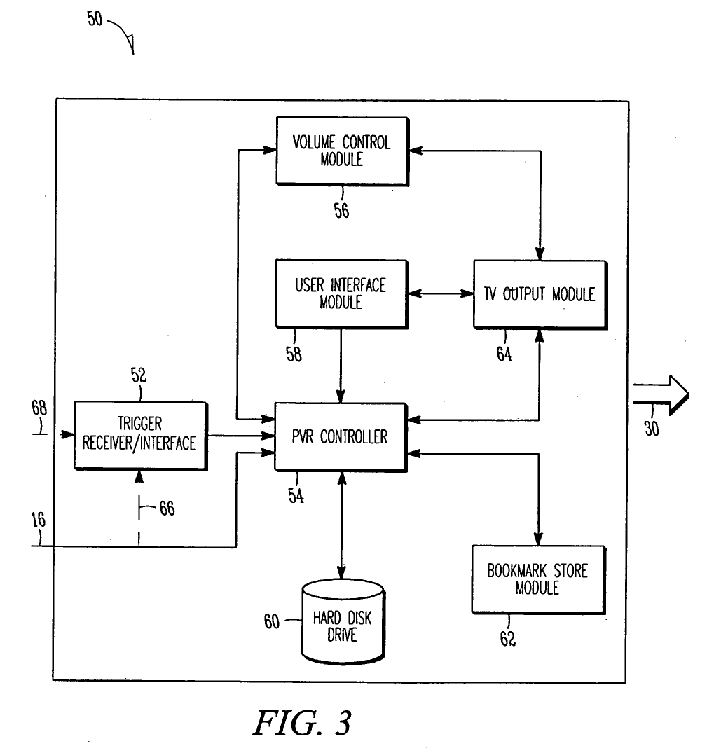

FIG. 3 shows architecture of an embodiment of a playback device in the example form of a set-top box 50. The set-top box 50 may resemble the set-top box 12 and only a few example modules of the set-top box 50 are shown. It will be appreciated by one skilled in the art, that several other or different functional modules may be included in the set up box 50. The set-top box 50 is shown to include a trigger receiver/interface 52 for receiving the trigger signal 20 and may extract caller identification information when present, and communicate with a PVR controller 54. The PVR controller 54 is shown to be connected to a volume control module 56, a user interface module 58, and a storage device in the form of hard disk drive 60, a bookmark store module 62, and a TV output module 64.

The volume control module 56 may control the volume of audio output by the TV output module 64 which is communicated to the television set 28. The user interface module 58 may, under control of the PVR controller 54, generate user interfaces which the TV output module 64 outputs to a television set. In a similar fashion to a conventional PVR, the hard disk drive 60 may store digital content such as television programs received by the set-top box 50 via the television network 18. When the set-top box 50 is deployed in the system 10, the trigger receiver/interface module 52 may extract the trigger signal (optionally including caller identification information) from the broadcast signal 16 as shown by arrow 66 in FIG. 3. However, when the set-top box 50 is deployed in the system 40, the trigger signal 20 (optionally including caller identification information) may be derived directly from the local telephony network 26 as shown by arrow 68 in FIG. 3. Further, in an embodiment where the set-top box 12 interfaces with a mobile device (e.g. a cellular telephone) the trigger receiver/interface 52 may include a Bluetooth communication module to communicate with the mobile telephone using Bluetooth communication protocols. It will, however, be appreciated to one skilled in the art that any communication protocol may be used to communicate with any mobile device. Further, in addition or instead, the trigger receiver/interface 52 may include a wireless network interface for interfacing the set-top box 50 with a wireless network, for example, a wireless network in a subscriber's home.

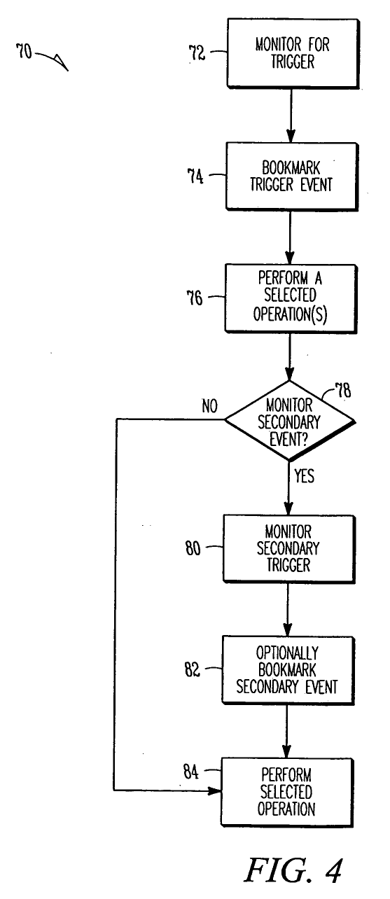

FIG. 4 shows an example method 70 to control operation of a playback device. In an example embodiment, the method 70 is used to control operation of the set-top box 50 and may be performed by, for example, the PVR controller 54. As shown at block 72, the method 70 monitors for the occurrence of a trigger event and, when a trigger signal is received, the method 70 may optionally bookmark the trigger event. For example, the PVR controller 54 may timestamp or create a tag associated with a particular point in a program being viewed and store bookmarks and other time stamped data in the bookmark storage module 62. In an embodiment, time stamping may be performed relative to a beginning of a program and not necessarily be a real time timestamp (e.g., time of day).

As shown at block 76, when a trigger signal is received from an external device, the PVR controller 54 (or any other component of the set-top box 50) may perform a selected operation. It will be appreciated that more than one operation may be performed when a trigger signal is received. Examples of selected operations include increasing audio volume, pausing playback, stopping playback, creating a bookmark, requesting confirmation from the viewer that a bookmark be created, requesting confirmation from the viewer that playback is stopped, requesting confirmation from the viewer that playback be paused, requesting confirmation from the viewer that audio volume be decreased, or the like. For example, the manipulation or operation performed on audio volume output by the TV output module 64 to the television set 28 may be performed by the volume control module 56. Continuing with the example, when a trigger event occurs, the volume control module 56 may mute the volume or decrease the volume to a predetermined level. For example, when the external device is baby monitor, a doorbell of a domestic dwelling, or the like, the volume control module 56 may mute the volume or reduce the volume so that the viewer can more clearly hear the baby monitor or doorbell. Thus, when a viewer's attention is requested by some other external device, the selected operation may be performed which, in the given example, is adjustment of the audio volume. In certain embodiments, the PVR controller 54 may request interaction or confirmation from a user or viewer that the selected operation is to be performed. For example, the PVR controller 54 may generate an interactive screen display interface requesting a user to confirm performance of the operation using a conventional remote control device of the set-top box 50.

In an example embodiment, as shown at decision block 78, the method 70 may include monitoring whether a multiple events take place (e.g., a primary event and a secondary event). For example, a primary event may be identified by the trigger signal 20 and may include, for example, a trigger indicating that the telephone 24 has been answered. Accordingly, as soon as a person answers the telephone 22, the PVR controller 54 may perform the selected operation (e.g., pause live TV or TV played back from the hard disk drive 60). Thereafter, a secondary event may be defined, for example, when the telephone call is terminated or the telephone is put down. Thus, as shown at block 80, a secondary trigger may be provided (e.g. to the trigger receiver/interface 52) and, as shown at block 82, optionally a further bookmark may be created to mark the secondary event. Thereafter, a further selected operation may be performed (see block 84). The further selected operation may, for example, be an operation to resume playback or outputting of the television program, to no longer mute or decrease the volume of the audio, automatically rewind or return to a point where a primary bookmark was created, or perform any other functionality provided by the set-top box 50.

In an embodiment where the playback device interfaces or operates in conjunction with a mobile platform such as a cellular telephone, the set-top box 50 may include a proximity sensor to sense when the cellular telephone is in proximity to the set-top box 50. For example, proximity sensing may be performed by Bluetooth circuitry provided within the set-top box 50 that communicates with the cellular telephone or any other mobile device incorporating Bluetooth technology. Thus, when a cellular telephone receives a telephone call, it may communicate with the set-top box 50 so that the set-top box 50 can perform the selected operation. It will, however, be appreciated that the mobile telephone need not communicate directly with the set-top box 50, but may receive a trigger signal indirectly from a mobile service provider. For example, a cellular network server may communicate the trigger signal with the broadcast signal 16 shown in FIG. 1.

The method 70 thus allows telephony events or any trigger events generated by external devices to be integrated into playback devices such as set-top boxes so that the playback device may perform a selected operation upon occurrence of the event. The selected operation may be performed on live content (e.g., a live television program), or prerecorded content (e.g., a recorded television program) which is being outputted or rendered by the playback device from a storage device. Although an embodiment includes functionality responsive to receiving a caller ID, it will be appreciated that this functionality is not required in all embodiments. For example, when the external device is not a telephony device, the caller identification information may not be provided. In an embodiment, the caller identification information may be included in bookmarks and, accordingly, a viewer may then return to various bookmarks associated with different incoming telephone calls. Further, it will be appreciated that the external trigger event may be digital and/or analogue in nature. When the trigger event is generated from a Voice over Internet Protocol (VoIP) telephone, the trigger signal may be sourced from a broadband connection to which the playback device is connected. Further, in an embodiment, the playback device (e.g. a set-top box or the like) may include a log of calls received. Further, the PVR controller 54 may include functionality to dismiss a call. For example, an interactive graphical user interface may be generated by the user interface module 58 for display on the television set 28 and the call may be dismissed by a viewer using a remote control device associated with the playback device. The selected operation performed by the PVR controller 54 may be performed automatically in certain circumstances without any human intervention. Thus, for example, if a user answers the telephone, the PVR controller 54 may automatically pause playback of a program (both live and recorded program). In certain embodiments, the method and system may be “retrofitted” into a conventional PVR or set-top box. For example, a conventional set-top box may be modified to include the functionality described herein.

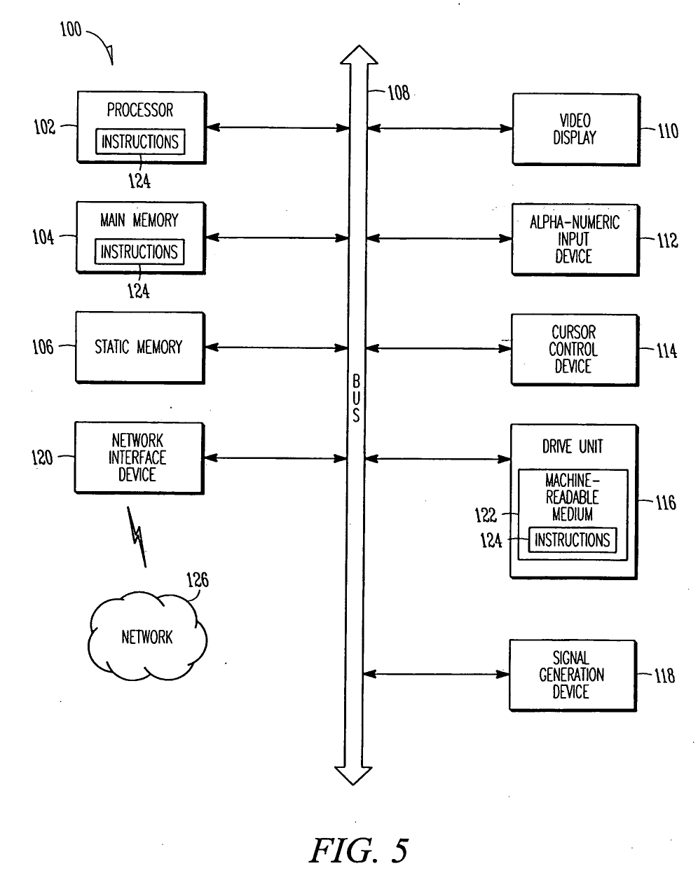

FIG. 5 shows a diagrammatic representation of machine in the example form of a computer system 100 within which a set of instructions, for causing the machine to perform any one or more of the methodologies discussed herein, may be executed. In alternative embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a server computer, a client computer, a personal computer (PC), a tablet PC, a set-top box (STB), a Personal Digital Assistant (PDA), a cellular telephone, a web appliance, a network router, switch or bridge, or any machine capable of executing a set of instructions (sequential or otherwise) that specify actions to be taken by that machine. Further, while only a single machine is illustrated, the term ‘machine’ shall also be taken to comprise any collection of machines that individually or jointly execute a set (or multiple sets) of instructions to perform any one or more of the methodologies discussed herein.

The example computer system 100 comprises a processor 102 (e.g., a central processing unit (CPU) a graphics processing unit (GPU) or both), a main memory 104 and a static memory 106, which communicate with each other via a bus 108. The computer system 100 may further comprise a video display unit 110 (e.g., a liquid crystal display (LCD) or a cathode ray tube (CRT)). The computer system 100 also comprises an alphanumeric input device 112 (e.g., a keyboard), a cursor control device 114 (e.g., a mouse), a disk drive unit 116, a signal generation device 118 (e.g., a speaker) and a network interface device 120.

The disk drive unit 116 comprises a machine-readable medium 122 on which is stored one or more sets of instructions (e.g., software 124) embodying any one or more of the methodologies or functions described herein. The software 124 may also reside, completely or at least partially, within the main memory 104 and/or within the processor 102 during execution thereof by the computer system 100, the main memory 204 and the processor 102 also constituting machine-readable media.

The software 124 may further be transmitted or received over a network 126 via the network interface device 120.

While the machine-readable medium 122 is shown in an example embodiment to be a single medium, the term ‘machine-readable medium’ should be taken to comprise a single medium or multiple media (e.g., a centralized or distributed database, and/or associated caches and servers) that store the one or more sets of instructions. The term ‘machine-readable medium’ shall also be taken to comprise any medium that is capable of storing, encoding or carrying a set of instructions for execution by the machine and that cause the machine to perform any one or more of the methodologies of the present invention. The term ‘machine-readable medium’ shall accordingly be taken to comprise, but not be limited to, solid-state memories, optical and magnetic media, and carrier wave signals.

Thus, a method and system to control operation of a playback device have been described. Although the present invention has been described with reference to specific example embodiments, it will be evident that various modifications and changes may be made to these embodiments without departing from the broader spirit and scope of the invention. Accordingly, the specification and drawings are to be regarded in an illustrative rather than a restrictive sense.

What is claimed is:

1. A method to control operation of a playback device, the method including:
receiving a trigger signal at the playback device, the trigger signal generated automatically without human intervention by an external device; and
performing at the playback device a selected operation on digital content being played back when the trigger signal is received.

2. The method of claim 1, in which the playback device includes a Personal Video Recorder (PVR) and the external trigger signal is received from the external device that is separate from a handheld remote control associated with the playback device.

3. The method of claim 2, which includes receiving the trigger signal directly from a telephony network, the trigger signal being an incoming call to a telephony device.

4. The method of claim 2, which includes receiving the trigger signal indirectly from a telephony network via a television network, the trigger signal being an incoming call to a telephony device.

5. The method of claim 2, which includes monitoring a telephone line connected to a telephony connection of the PVR, the trigger signal being an incoming call signal on the telephone line.

6. The method of claim 2, which includes:
receiving the trigger signal via a telephony network;
receiving caller identification information with the trigger signal; and providing the caller identification to a display device connected to the playback device.

7. The method of claim 2, which includes receiving the trigger signal from a mobile telephone in proximity to the playback device.

8. The method of claim 7, which includes receiving the trigger signal via a Bluetooth communication link from the mobile telephone.

9. The method of claim 2, wherein the external trigger is received from an appliance, the trigger signal being responsive to an alert generated by the appliance.

10. The method of claim 9, wherein the appliance is a household cooking appliance.

11. The method of claim 1, wherein the trigger signal is received via a wireless home network.

12. The method of claim 1, wherein the selected operation is selected from one or more of decreasing audio volume, pausing playback, stopping playback, creating a bookmark, requesting confirmation from the viewer that a bookmark be created, requesting confirmation from the viewer that playback be stopped, requesting confirmation from the viewer that that playback be paused, and requesting confirmation from the viewer that audio volume be decreased.

13. A machine-readable medium including instructions which, when executed by a machine, cause the machine to perform the method of claim 1.

14. A playback device to output digital content to a display device, the playback device including:
a receiver to receive digital content via a content distribution network;
a display device interface for outputting content to the display device;
a storage device to selectively store the content;
a controller connected to the receiver, display device interface and the storage device to control operation of the playback device; and
a trigger interface to receive a trigger signal from an external device, the trigger signal generated automatically without human intervention by the external device and the controller performing a selected operation on digital content being played back when the trigger signal is received.

15. The playback device of claim 14, wherein the trigger interface is a telephone connector to connect the playback device to a wired telephone network.

16. The playback device of claim 14, wherein the trigger interface is a wireless network interface.

17. The playback device of claim 14, wherein the selected operation is selected from one or more of decreasing audio volume, pausing playback, stopping playback, creating a bookmark, requesting confirmation from the viewer that a bookmark be created, requesting confirmation from the viewer that a playback be stopped, requesting confirmation from the viewer that that playback be paused, and requesting confirmation from the viewer that audio volume be decreased.

18. The playback device of claim 14, which includes a Personal Video Recorder (PVR) and the external trigger signal is received from the external device that is separate from a handheld remote control associated with the playback device.

19. A playback device to output digital content to a display device, the playback device including:
means for receiving a trigger signal at the playback device, the trigger signal generated automatically without human intervention by an external device;
means for performing at the playback device a selected operation on digital content being played back when the trigger signal is received.

20. A method of controlling operation of a playback device that outputs content for display, the method including:
receiving at the playback device a trigger signal from an external device, the trigger signal being generated automatically in response to the external device requesting attention of a viewer of the content; and
performing at the playback device a selected operation on digital content being rendered for display when the trigger signal is received.
